(19) United States
(12) Patent Application Publication
(10) Pub. No.: US 2019/0133381 A1
(43) Pub. Date: May 9, 2019

(54) CUTTING BOARD WITH REMOVABLE CUTTING SURFACE

(71) Applicant: Yishai Auerbach, Bnei Brak (IL)

(72) Inventor: Yishai Auerbach, Bnei Brak (IL)

(21) Appl. No.: 16/045,969

(22) Filed: Jul. 26, 2018

(30) Foreign Application Priority Data
Jul. 26, 2017 (IL) 253671

(51) Int. Cl. A47J 47/00

(52) U.S. Cl. CPC A47J 47/005

(57) ABSTRACT

A cutting board includes a cutting surface assembled on a support surface, and corner fasteners that fasten the cutting surface on the support surface. At least some of the corner fasteners are releasable to detach the cutting surface from the support surface.

### FIELD OF THE INVENTION

The present invention generally relates to cutting boards, and particularly to a cutting board with a removable cutting surface.

### BACKGROUND OF THE INVENTION

Cutting boards are used for cutting or slicing various food products, such as but not limited to, vegetables, fruits, meats, fish and bread.

In the case of a bread cutting board, crumbs gather around the board when cutting the bread. Some bread cutting boards have a cutting surface held in a frame. In such a construction, there is usually a small gap between the outer edges of the cutting surface and the inner edges of the frame. This is disadvantageous, because the crumbs can fall into this gap and it is difficult and cumbersome to remove the crumbs from the gap.

### SUMMARY OF THE INVENTION

The present invention seeks to provide an improved cutting board with a removable cutting surface, as is described more in detail hereinbelow.

The invention is particularly advantageous for use as a bread cutting board, because the cutting surface is easily removed from a frame, making removal of crumbs easy and straightforward.

There is thus provided in accordance with an embodiment of the present invention a cutting board including a cutting surface assembled on a support surface, and corner fasteners that fasten the cutting surface on the support surface, at least some of the corner fasteners being releasable to detach the cutting surface from the support surface.

In accordance with an embodiment of the present invention the corner fasteners include corner pockets and corner edges of the cutting surface slip under the corner pockets and rest on the support surface.

In accordance with an embodiment of the present invention the corner fasteners have a non-straight decorative edge.

In accordance with an embodiment of the present invention the corner fasteners are pivotally connected to the support surface and have a first connector that fastens on to a corresponding second connector mounted on the support surface.

### BRIEF DESCRIPTION OF THE DRAWINGS

The present invention will be understood and appreciated more fully from the following detailed description taken in conjunction with the drawings in which:

FIG. 1 is a simplified illustration of a cutting board, constructed and operative in accordance with a non-limiting embodiment of the present invention; and

FIG. 2 is an enlarged view of a corner of the cutting board.

### DETAILED DESCRIPTION OF EMBODIMENTS

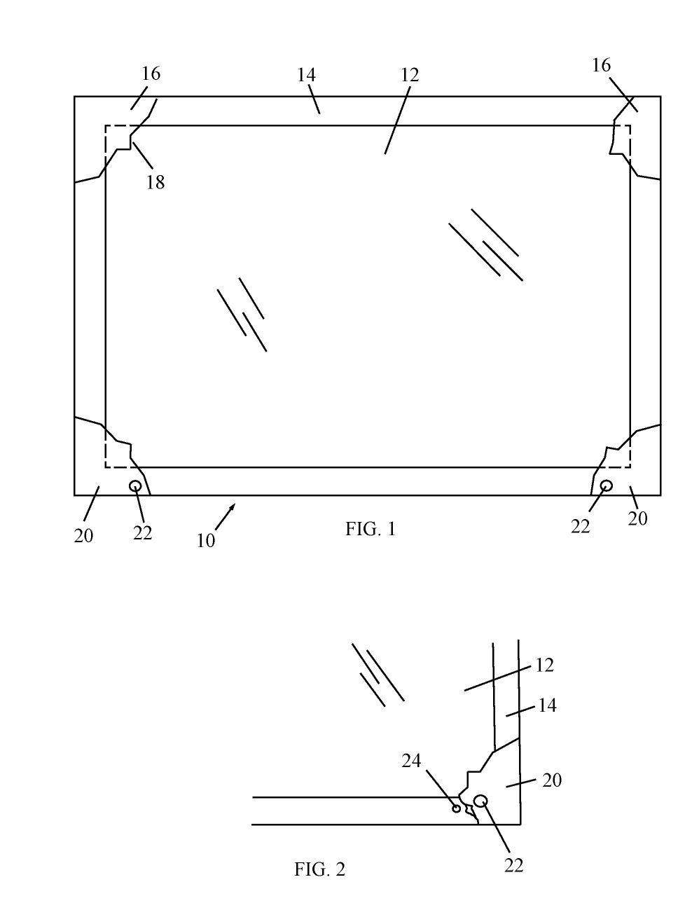

Reference is now made to FIG. 1, which illustrates a cutting board 10, in accordance with a non-limiting embodiment of the present invention.

Cutting board 10 includes a cutting surface 12 assembled on a support surface 14. In one embodiment, cutting surface 12 is made of a smooth material, such as but not limited to, glass, plastic (e.g., polymethylmethacrylate), metal and others. In other embodiments, cutting surface 12 may include ribs, splines, grids and other spaced apart members. In such a construction, crumbs may fall between the spaces of the spaced apart members on to the support surface 14.

The support surface 14 may be made of a material, which is the same as that of cutting surface 12. Alternatively, support surface 14 may be made of a material, which is different than cutting surface 12. For example, support surface 14 may be made of a material, which is softer than cutting surface 12, such as but not limited to, leather, cloth, plastic, certain woods and many others. As another alternative, support surface 14 may be made of a material, which is harder than cutting surface 12, such as but not limited to, certain woods, metals and many others.

The cutting surface 12 and support surface 14 may be rectangular, square, polygonal, oval, circular and other shapes.

In accordance with a non-limiting embodiment of the present invention, cutting surface 12 may be assembled on support surface 14 by means of corner fasteners. For example, two upper corner fasteners 16 may be corner pockets, which may have a non-straight decorative edge 18 that faces towards the central area of cutting surface 12. The corner edges of cutting surface 12 slip under the upper corner fasteners 16 and rest on support surface 14. Two lower corner fasteners 20 may be used to secure cutting surface in place. For example, two lower corner fasteners 20 may be pivotally connected to support surface 14 and have a first connector 22 that fastens on to a corresponding second connector 24 (FIG. 2) mounted on support surface 14. For example, in the illustrated embodiment, the first and second connectors 22 and 24 are snap connectors. Alternatively, they may multi-hook fasteners (e.g., Velcro strips), buckles, straps, ties, screws, and the like.

The two lower corner fasteners 20 may be shaped similar to (or different from) upper corner fasteners 16. The upper corner fasteners 16 and the lower corner fasteners 20 may be made of leather, cloth, metal, plastic and any other suitable material.

In use, the person cuts bread or other foodstuff on cutting surface 12 while it is secured to support surface 14 with upper corner fasteners 16 and lower corner fasteners 20. In the case of cutting bread, any crumbs, which may get trapped between cutting surface 12 and support surface 14 or in any of the upper corner fasteners 16 and lower corner fasteners 20, are easily removed by simply detaching cutting surface 12 from support surface 14 releasing the lower corner fasteners 20.

It is noted that all four corner fasteners may alternatively be only of the kind of upper corner fasteners 16 or only of the kind of lower corner fasteners 20.

It is further noted that corner fasteners are considered superior to a peripheral fastener that fastens the entire or majority of the perimeter of cutting surface 12 to support surface 14. The reason is the lower corner fasteners 20 may be released without having to remove the entire cutting surface 12 from support surface 14; instead the lower corner fasteners 20 may be released and the cutting surface 12 may be tilted up while still being held to support surface 14 with the upper corner fasteners 16. This is also superior to hinges in which crumbs can get trapped.

What is claimed is:

1. A cutting board comprising:
a cutting surface assembled on a support surface; and
corner fasteners that fasten said cutting surface on said support surface, at least some of said corner fasteners being releasable to detach said cutting surface from said support surface.

2. The cutting board according to claim 1, wherein said corner fasteners comprise corner pockets and corner edges of said cutting surface slip under said corner pockets and rest on said support surface.

3. The cutting board according to claim 1, wherein said corner fasteners have a non-straight decorative edge.

4. The cutting board according to claim 1, wherein said corner fasteners are pivotally connected to said support surface and have a first connector that fastens on to a corresponding second connector mounted on said support surface.

5. The cutting board according to claim 4, wherein said first and second connectors comprise snap connectors.

6. The cutting board according to claim 1, wherein said support surface is made of a material which is softer than said cutting surface.
